(19) United States
(12) Patent Application Publication
(10) Pub. No.: US 2006/0224772 A1
(43) Pub. Date: Oct. 5, 2006

(54) Apparatus and computer readable medium for transporting and processing digital media

(75) Inventor: Damian Saccocio, Washington, DC (US)

Correspondence Address: ARNOLD & PORTER LLP;ATTN: IP DOCKETING DEPT., 555 TWELFTH STREET, N.W., WASHINGTON, DC, 20004-1206, US

(73) Assignee: Digital Shoeboxes LLC

(21) Appl. No.: 11/097,880

(22) Filed: Apr. 4, 2005

(51) Int. Cl. G06F 15/173

(52) U.S. Cl. 709/238

(57) ABSTRACT

The present invention is directed providing a simple and convenient way for consumers to organize, share and display their digital media. According to an embodiment, a consumer can transfer data to a server, which will automatically prepare copies of the data and deliver them to the consumer, transfer the data to a predetermined group of recipients, and store the data for future review and manipulation by the consumer.

### FIELD OF THE INVENTION

The present invention relates to digital media collection and display. In particular, the present invention is directed to providing a simple and convenient way for consumers to organize, edit, publish, print, share, archive and display their digital media.

### BACKGROUND OF THE INVENTION

Today's world of consumer digital media devices is one of rapid growth, but low satisfaction. It is a situation not completely unlike that of the early 1900s when the communications and media industries were first evolving into global industries around radio, photography, and the telephone (not to mention transportation advances with regard to automobiles, airplanes, and trains). During this time, the technology often worked but it was not always easy. Radio was for communication not entertainment. Telephones networks were mostly entirely local and typically non-interoperable. The present invention seeks to integrate and simplify the work flow associated with digital media such that the typical consumer can focus on the enjoyment and sharing of their media, rather than the tedious set tasks required today.

The components to digitally acquire, store, transport, process, playback and display media are now at a price/performance point that makes such devices very affordable for the average consumer. Unfortunately, many digital media devices remain PC-centric. Increasingly, users desire devices that can speak directly to internet-based services via home broadband networks. This is not to say that the PC is no longer an important media platform to the average user; only that many users now desire services that are not dependent upon the PC to function.

### SUMMARY OF THE INVENTION

The present invention is directed to providing a simple and convenient way for consumers to organize, edit, publish, print, share, archive and display their digital media. According to an embodiment, a consumer can transfer data to a server, which will automatically, with or without some human intervention, prepare copies of the data and deliver them to the consumer, transfer the data to a predetermined group of recipients, and store the data for future review and manipulation by the consumer. Additional uses for the present invention will become clear from the following description.

### BRIEF DESCRIPTION OF THE DRAWINGS

FIG. 1 is a diagram of a consumer networking apparatus according to an embodiment of the present invention.

FIG. 2 is a diagram of a sortable digital data storage apparatus according to an embodiment of the present invention.

FIG. 3 is a diagram of a digital media collection system according to an embodiment of the present invention.

### DESCRIPTION OF PREFERRED EMBODIMENTS OF THE INVENTION

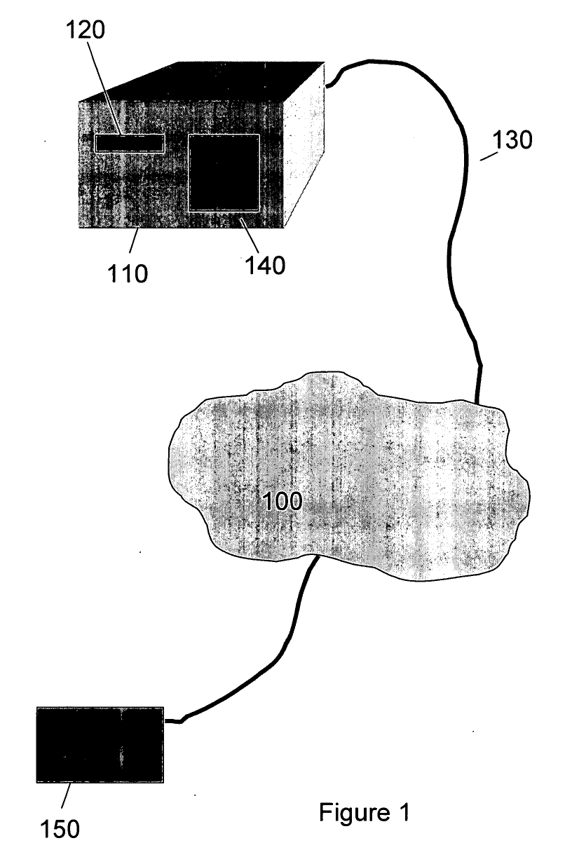

The present invention may be implemented over a computer network 100, as shown in FIG. 1. The computer network connects multiple computers and computer devices together so that they can share information. An example of such a computer network is the Internet. According to an embodiment, the present invention may be implemented over the Internet. A dedicated consumer networking apparatus 110 can include one or more device readers 120. As will be understood by one of skill in the art, device readers 120 can accept media of various shapes and sizes. According to an embodiment of the invention, the device reader 120 can be designed to accept digital media in standard sizes. Some examples of such media are SD, MMX, XD, Flash Memory, Memory Stick, and Smart Media memory cards, CDs, DVDs, and MiniDV tapes. These examples are meant as explanatory examples, and do not limit the extent of the present invention. One of skill in the art will recognize that many other standard digital media sizes can be accepted. Alternatively, according to an embodiment of the invention, the device reader 120 can be designed to accept non-standard size digital media. The dedicated consumer networking apparatus 110 can also include an analog memory slot 140. The analog memory slot 140 can also be designed in various shapes and sizes to accept many standard or non-standard types of memory. Some examples of such analog memory which are given by way of example, and not to limit the present invention, are audiocassette tapes, VHS tapes, and VHS-C tapes. The analog memory slot 140 can also include an analog to digital converter to convert the data stored on the analog media into digital data, as would be understood by one of skill in the art. The dedicated consumer networking apparatus 110 can include one or many media slots. Additionally, according to an embodiment, additional media slots with their own external housing can be added on to the dedicated consumer networking apparatus 110. The dedicated consumer networking apparatus 110 can include a variety of hardware and software that can process the data from the digital and analog memory slots 120 and 140. The dedicated consumer networking apparatus 110 can also contain a networking interface that can connect to a network, for example, the Internet. Other networks could also be used. According to an embodiment of the present invention, the networking interface would be dedicated to transferring the data read by digital or analog memory slots 120 or 140 to a predetermined location, although the network interface may be capable of processing other types of network operations as well. According to an embodiment, the location that will receive the data will be predetermined, and programmed in the hardware and/or software of the dedicated consumer networking apparatus 110 such that the user does not need to enter any information about the destination of the data. Accordingly, a consumer can utilize the dedicated consumer networking device by inserting media into the digital or analog memory slot 120 or 140. The dedicated consumer networking apparatus 110 can be activated by the insertion of the media, or the pressing of a button, or some other activation, as will be understood by one of skill in the art. The dedicated consumer networking apparatus 110 can read the media and automatically transfer it to a predetermined location 150 over the network. This is described by way of example, and is not meant to limit the scope of the present invention. As seen in FIG. 1, the dedicated consumer networking apparatus 110 can be connected to a network by a wire 130. The dedicated consumer networking apparatus 110 can be connected to a network in many other ways, such as wirelessly, as will be understood by one of skill in the art. The dedicated consumer networking apparatus 110 can be enabled to connect to the network automatically.

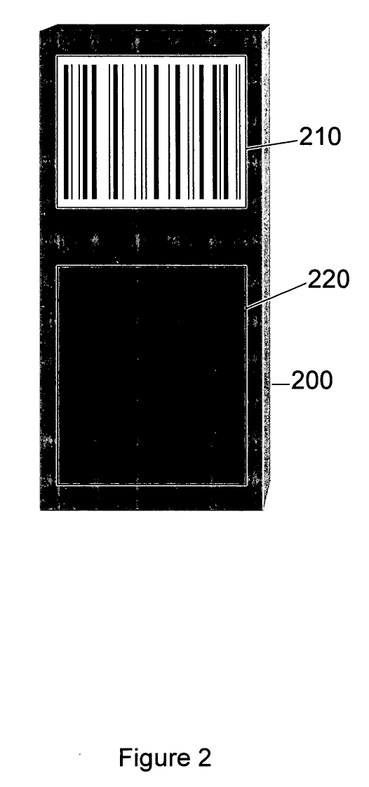

Turning to FIG. 2, a digital data storage apparatus is shown. The digital data storage apparatus can include an external housing 200, a flash memory 220 and a unique identifier 210. According to an embodiment of the invention, the external housing 200 can be compatible with standard sizes for digital media. Examples have been given above. Alternatively, the external housing 200 can be a custom size or shape. The external housing 200 will also allow an interface with the flash memory 220, as will be understood by one of skill in the art, so that a media reader can read the data stored on the flash memory 220. This could include, for example, metal contacts on the outside of the external housing 200 that connect the flash memory 220. The present invention includes many different types of unique identifier 210. By way of example only, this could include a bar code, a digital number, a radio frequency identification (RFID), or other unique identification device. The unique identifier 210 can be attached to the inside or outside of the external housing 200 so that it does not easily fall off. By way of example, this attachment could be by means of an adhesive, such as a sticker. According to another embodiment, the unique identifier 210 can be encoded on the flash memory. According to yet another embodiment, the unique identifier 210 can be printed on or imprinted in the external housing 200. According to yet another embodiment, the unique identifier 210 can be enclosed inside the external housing 200.

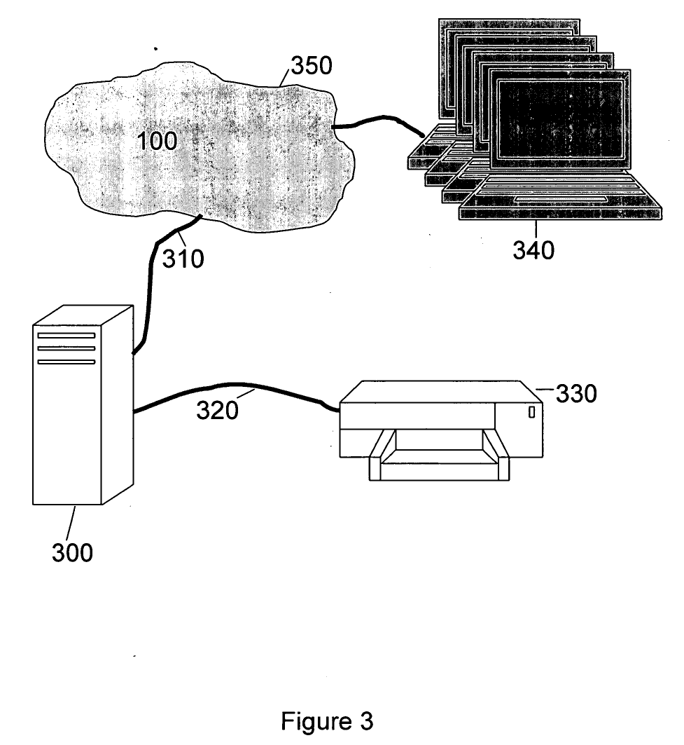

Turning now to FIG. 3, a diagram of a digital media collection system in accordance with the present invention is shown. According to an embodiment of the invention, server 300 receives data from consumers. One of skill in the art will understand that server 300 can include any number of servers or computers. The server could be fully automated, or may operate with some degree of human interaction. As discussed above, digital or analog data can be read from a digital or analog media device and transferred over a network 100 to a predetermined location, such as server 300. This could occur with or without the involvement of a personal computer. According to an embodiment, a dedicated consumer networking apparatus 110 can be used to transfer the data over a network without the use of a personal computer. Similarly, a media card reader in a personal computer can be used to transfer the data using a computer. According to another embodiment, data can be loaded directly onto server 300. By way of example, this could include a consumer mailing digital media cards to a vendor, who can copy data from the digital media cards directly or indirectly onto the server 300. Blank replacement digital media cards can then be returned to the consumer. Alternatively, or additionally, a consumer could transmit digital media to the server 300 via email, instant messaging, or a website over the Internet.

The server 300 can then process the data received from the consumers. This data, by way of example, could include photographic images, video imaging, audio recording, or other forms of recordings, as will be known to one of skill in the art. According to an embodiment of the invention, the server 300 can process the data to optimize it. For example, digital photos can be processed to optimize the brightness and tint of the photos, and to reduce red-eye effect, among other things. Other forms of data can likewise be processed.

The server 300 can then prepare copies of the data to send to the consumer. According to an embodiment, this could include printing digital photos via photographic printer 330. The printed photos can then be mailed to the consumer or a recipient specified by the consumer. By way of example, this could also include preparing a CD or DVD containing the data to send to the consumer or a recipient specified by the consumer. One of skill in the art will recognize that the data can be prepared for delivery to the consumer in other formats as well.

The server 300 can also prepare and transmit the data to a specified group of recipients 340. According to an embodiment, the preparation can mean simply packaging the data so that it can be sent in the desired format. By way of example, the server can prepare the data for transmittal via email, and send the email over the internet. The data could also be transmitted to the specified group of recipients 340 by preparing physical copies of the data, such as printed photographs, and mailing them to the specified group of recipients 340. According to an embodiment of the invention, the consumer can specify what recipients will be included in the specified group of recipients 340.

The server 300 can also save the data received from the consumers. According to an embodiment of the invention, this could be accomplished through the use of a computer storage medium, or storage device, as will be understood by one of skill in the art. The saved data can be accessible to the consumer through the network. By way of example, the consumer could access the data through a website over the Internet. The data can be viewed and manipulated by the consumer, and the consumer can request additional copies of the data, among other things.

It should be understood that all examples given in this description are meant only to be illustrative of embodiments of the present invention. They are not meant to limit the invention in any way.

I claim:

1. A consumer networking apparatus, dedicated to process and send information from digital media, comprising:
a first digital media reader for reading first data from a first digital media source,
and a dedicated network interface, capable of connecting to a network and automatically routing said first data to a predetermined remote data processing location.

2. The apparatus of claim 1, wherein said network interface is capable of connecting to a wireless network.

3. The apparatus of claim 1, further comprising
a second media reader for reading second data from a second media,
and wherein said network interface is capable of automatically routing second data to a predetermined remote data processing location.

4. The apparatus of claim 1, further comprising a display to indicate the status of said first data.

5. The apparatus of claim 3, wherein said second data is a digital translation of analog data on said second media.

6. The apparatus of claim 1, wherein said network is the internet, and said remote data processing location is a website.

7. A sortable digital data storage apparatus, comprising:
a flash memory, a unique identifier, packaged together with said flash memory, that can be automatically sorted according to predetermined criteria.

8. The apparatus of claim 7, wherein said flash memory and said unique identifier are packaged together such that the packaging is compatible with a standard flash memory reader device.

9. The apparatus of claim 7, wherein said unique identifier is a bar code.

10. The apparatus of claim 7, wherein said unique identifier is a radio frequency identification device.

11. The apparatus of claim 7, wherein said unique identifier is attached to a standard flash memory device containing a flash memory.

12. The apparatus of claim 7, wherein said unique identifier is encoded on said flash memory.

13. A computer readable medium for collecting and processing data on digital media, the computer readable medium having one or more computer modules executable on one or more computer processors, the computer modules carrying out the following acts:
receiving data from a consumer,
storing said data in memory,
preparing said data for delivery,
automatically distributing said data to a predetermined set of data recipients,
and presenting said data for review by said consumer.

14. The medium of claim 13, wherein said data is received from said consumer encoded in a flash memory device.

15. The medium of claim 13, wherein said data is received from said consumer over a network.

16. The medium of claim 13, wherein said data comprises digital photos.

17. The medium of claim 13, wherein said data comprises video.

18. The medium of claim 13, wherein said data comprises audio.

19. The medium of claim 13, further comprising processing said data to enhance said data.

20. The medium of claim 14, further comprising:
detecting a unique identifier on said flash memory device,
and processing said data according to a procedure linked to said unique identifier.

21. The medium of claim 13, further comprising allowing said consumer to predetermine said set of data recipients.
